(19) United States
(12) Patent Application Publication
(10) Pub. No.: US 2025/0390130 A1
(43) Pub. Date: Dec. 25, 2025

(54) CORRECTION CIRCUIT FOR DYNAMICALLY ADJUSTING A PARAMETER OF A LOW DROPOUT REGULATOR BASED ON SENSOR DATA

(71) Applicant: Infineon Technologies LLC, San Jose, CA (US)

(72) Inventors: Eran GEYARI, Netanya (IL); Avri Harush, Herzliya (IL)

(73) Assignee: Infineon Technologies LLC, San Jose, CA (US)

(21) Appl. No.: 18/891,925

(22) Filed: Sep. 20, 2024

Related U.S. Application Data
(60) Provisional application No. 63/662,137, filed on Jun. 20, 2024.

(51) Int. Cl. G05F 1/575; G05F 1/567

(52) U.S. Cl. CPC G05F 1/575; G05F 1/567

(57) ABSTRACT

Technologies related to low dropout regulation circuitry stabilization are described. A circuit includes an amplifier to supply a voltage based on a comparison of a feedback loop voltage and a reference voltage. A comparison circuit coupled to the amplifier dynamically adjusts an amount of current supplied to the amplifier based on a measured temperature.

### CROSS-REFERENCE TO RELATED APPLICATIONS

This application claims the benefit of U.S. Provisional Application No. 63/662,137, filed Jun. 20, 2024, the entire contents of which are incorporated herein by reference.

### BACKGROUND

Electronic circuits may include individual electronic components, such as resistors, transistors, and capacitors, among others, connected by conductive wires or traces through which electric current can flow. Electronic circuits may be constructed using discrete components, or more commonly integrated in an integrated circuit (IC) where the components and interconnections are formed on a common substrate, such as silicon.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a circuit with low dropout regulator (LDO) circuitry, according to one embodiment.

FIG. 2 illustrates a circuit with LDO circuitry, according to one embodiment.

FIG. 3 illustrates a circuit with LDO circuitry, according to one embodiment.

FIG. 4 illustrates a portion of a system, according to one embodiment.

### DETAILED DESCRIPTION

Technologies related to low dropout regulation (LDO) circuitry stabilization are described. In general, an LDO is designed to provide a stable output voltage with a small difference (low dropout voltage) between input and output voltages. LDOs are commonly used in many different products, including flash memory products, microcontrollers, smartphones, wearable devices, and other battery-powered electronics. In many applications, the LDO may be part of an integrated circuit (IC) or provide voltage regulation support to an IC. ICs generally have specifications or standards to be met, such as a maximum supply current (I_{CC}) draw when the IC is below a certain temperature and the IC is in standby. For example, an LDO may have a maximum desired supply current I_{CC} draw while the LDO is operating at typical temperatures, such as room temperature. This maximum desired supply current I_{CC} may be referred to as a typical specification (TYP specification), as it is a specification that corresponds to a typical operating environment. This typical specification may be much lower than a supply current I_{CC} specification while the LDO operates at higher temperatures. While IC leakage draws supply current I_{CC} during standby, other circuitry, such as the LDO, also draws supply current I_{CC}. Conventional LDOs may be designed to accommodate the maximum supply current I_{CC} specification or standard.

LDOs may also have stability requirements with respect to a load current (i.e., current drawn from LDO by components of the IC) that is dependent on temperature. Here, as temperature increases, the load current increases. In some cases, the load current may increase exponentially as the temperature of the IC increases. This load current increase results in a greater LDO current output as temperature increases, and without changing an LDO operating point (such as supply current I_{CC} draw), the LDO has an increased likelihood of becoming unstable. Instability of the LDO can result in malfunctions such as oscillation of LDO output, high supply current I_{CC} draw during standby, or the like.

Conventional LDO stability design may call for increasing the LDO supply current I_{CC} draw during standby to handle the worst-case scenario load current. However, by doing so, the maximum supply current I_{CC} specification will not be met. Other conventional approaches to the above LDO stability challenge include placing a large capacitor on the IC or outside of the IC, usually in the nanofarad or microfarad range. However, this can significantly increase die size, increase IC design complexity, or occupy a significant amount of area on the IC. Another approach includes designing circuitry that observes the load current or other IC leakage and accordingly adjusts the LDO supply current I_{CC} draw. However, this approach would require additional current draw by the IC, which would detrimentally affect the maximum supply current I_{CC} specification and may also include designing an additional loop within the LDO, which may cause other LDO stability issues.

Aspects and embodiments of the present disclosure address the problems and challenges addressed above and others by providing a correction circuit that can dynamically adjust an amount of supply current I_{CC} supplied to the LDO based on a measured temperature. The measured temperature corresponds to an IC upon which the LDO may be disposed. In one embodiment, the LDO is not disposed on the IC. Aspects and embodiments of the present disclosure may utilize temperature data corresponding to this measured temperature to dynamically adjust the amount of supply current I_{CC} supplied to the LDO. As the measured temperature increases, the correction circuit may increase the amount of supply current I_{CC} supplied to the LDO. As the measured temperature decreases, the correction circuit may decrease the amount of supply current I_{CC} supplied to the LDO. The correction circuit may include multiple current sources that are configured to selectively couple to the LDO based on the measured temperature. Some of these current sources may supply different amounts of current. More of these current sources may be enabled at a time when the measured temperature is high than at a time when the measured temperature is low. The temperature data may be a thermometer code that represents the measured temperature. The bits of the thermometer code may be represented by signals carried over parallel lines to control terminals of pass elements coupled to the current sources. The pass elements may allow current to pass from their respective current sources to the LDO based on the thermometer code.

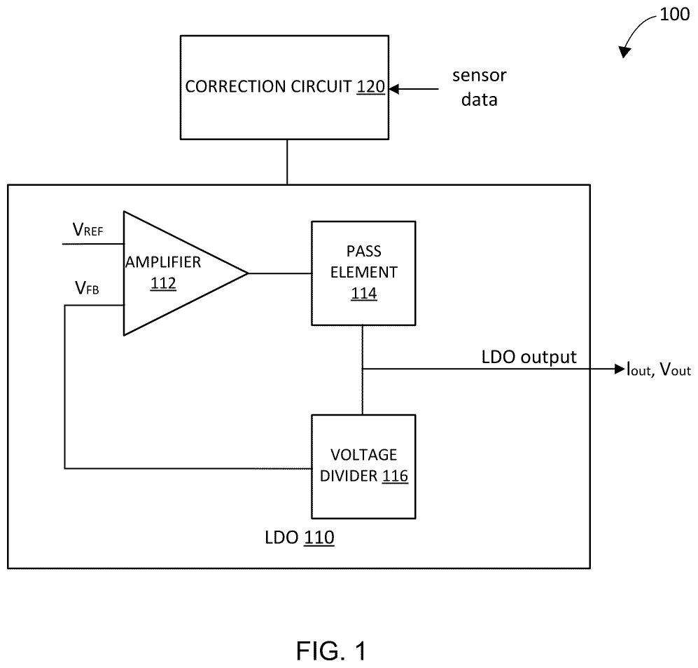

FIG. 1 illustrates a circuit 100 with low dropout regulator (LDO) circuitry, according to one embodiment. In some embodiments, the circuit 100 may be part of an integrated circuit (IC). In at least one embodiment, the circuit 100 is not disposed on the IC. According to embodiments, the circuit 100 is configured to provide power supply regulation to the IC (i.e., via the LDO circuitry). The circuit 100 may include an LDO 110 and a correction circuit 120. In general, LDO circuits are designed to maintain a constant output voltage while minimizing the difference between the input voltage and the output voltage. This difference between input and output voltage may be referred to as the dropout voltage. An LDO circuit may typically include several different components that facilitate its operation, such as an error amplifier and a feedback loop. The error amplifier may compare the LDO output voltage with a reference voltage to maintain voltage stability and accuracy. This reference voltage may change depending on whether the LDO (or chip to which the LDO belongs) is in a standby mode or an active mode. The feedback loop may typically be employed to adjust the LDO output voltage based on changes in load or input voltage. In at least some embodiments, the feedback loop may include a voltage divider. Additional components that may also be commonly found in LDO circuits include a pass element 114 (e.g., a transistor) that regulates the current flow; a compensation network to facilitate stability; and various protection features like overcurrent and thermal shutdown mechanisms. In general pass elements act as a gatekeeper to current flow and determine whether current may flow (or a strength at which the current may flow) via the pass elements based on a signal or voltage level at its control terminal. While the configuration of LDO regulators may vary to suit specific applications, the aspects and embodiments of the present disclosure are applicable to any LDO that transitions between standby and active modes.

As illustrated, the LDO 110 may include at least an amplifier 112, a pass element 114, and a voltage divider 116 that form a feedback loop. This feedback loop may generate a feedback voltage V_{FB} that is compared by the amplifier 112 to a reference voltage V_{REF}. The feedback voltage V_{FB} may be a fraction of an LDO output voltage V_{OUT}. During operation of the LDO 110, the amplifier 112 may output an error signal proportional to any difference between the feedback voltage V_{FB} to the reference voltage V_{REF}. This error signal may be directly related to the stability of the LDO output voltage V_{OUT} despite any variations in load or supply voltage V_{DDD}. In some embodiments, the amplifier 112 may be an error amplifier. In other embodiments, the amplifier 112 may be any suitable type of amplifier that may be used in an LDO circuit. The pass element 114 may be comprised of any component(s) that allow a current to flow based on an independent control signal. For example, the pass element 114 may be one or more a group of components, including but not limited to transistors, relays, diodes, flip-flops (FFs), multiplexers, and the like. The voltage divider 116 may be any group of component(s) that split a voltage into a smaller voltage. In many cases, voltage dividers comprise two in-series resistors. However, the voltage divider 116 may include other suitable components, such as such as potentiometers, capacitors, thermistors, varistors, or the like.

The circuit 100 may also include a correction circuit 120. The correction circuit 120 may be configured to modify or change a parameter of the LDO 110 based on received sensor data. For example, the correction circuit 120 may be configured to supply an amount of current (e.g., supply current I_{CC}) to the amplifier 112 based on received temperature data representing a measured temperature of the IC. In some embodiments, the correction circuit 120 may be configured to modify or change other parameters of the LDO 110 or surrounding circuitry that affect LDO stability, such as modifying a resistor network (e.g., the voltage divider 116), adjusting an internal capacitance of the LDO 110, modifying the reference voltage V_{REF}, or the like. The received sensor data may be any sensor data related to LDO stability, such as temperature, operational speed data (e.g., clock frequency), or process variation data, or voltage level data of the IC. In some embodiments, this sensor data may correspond to observations made by a process, voltage, and temperature (PVT) sensor or a thermometer.

In some embodiments, the correction circuit 120 may be configured to modify a parameter of the LDO 110 based on a measured temperature. In at least one embodiment, the correction circuit 120 may include multiple parallel paths that, upon being enabled or disabled, modify the parameter of the LDO 110. For example, if the correction circuit 120 is to modify an amount of supply current I_{CC} supplied to the amplifier 112, these parallel lines may be coupled between a power supply (not illustrated) and the amplifier 112. In this example, these parallel paths may be selectively enabled or disabled based on the sensor data representing the measured temperature. By enabling a larger number of these parallel paths, the correction circuit 120 can increase the supply current I_{CC} provided to the amplifier 112. By enabling a smaller number of these parallel paths, the correction circuit 120 can decrease the supply current I_{CC} provided to the amplifier 112. The number of parallel paths that are enabled at a given time may be based on the measured temperature. For example, the correction circuit 120 can provide a first amount of current at a first time based on a first measured temperature by enabling a first number of parallel paths. Then, at a second time, the correction circuit 120 can provide a second amount of current based on a second measured temperature that is different from the first measured temperature by enabling a second number of parallel paths that is different from the first number.

In some embodiments, this sensor data may be a thermometer code (thermocode). In this context, this thermocode may be a binary representation of a last measured temperature or other observation made by a sensor. This thermocode may be carried by parallel lines, where each line represents a bit in the binary output of the digital conversion of the measured temperature (or other sensor observation). The below table (2) represents possible exemplary 4-bit thermocodes representing the measured temperature:

TABLE 1

| Range of temperatures (Celsius (C.)) | Thermocodes |
|---|---|
| <0° | 0000 |
| 0-25° | 0001 |
| 25-50° | 0011 |
| 50-75° | 0111 |
| 75-100° | 1111 |

In this exemplary embodiment, the correction circuit 120 may include at least four parallel paths that can each be selectively enabled based on one of the bits of the thermocode. For example, if the measured temperature is less than 0° C., all four of the parallel paths may be disabled. As another example, if the measured temperature is 55° C., three of the parallel paths may be enabled while the fourth parallel path may be disabled.

The above thermocodes described with respect to table (1) are meant solely as examples, and that thermocodes and their corresponding temperature ranges (or other ranges of a characteristic measured by a sensor) can widely vary. For example, a thermocode can have more or less than four bits and each range of temperatures corresponding to a particular thermocode configuration can be smaller or greater than 25° C. For example, if a high level of granularity within a particular temperature range is desired, the thermocode may be designed to have 50+ bits and corresponding parallel lines. In this scenario, the correction circuit 120 may include at least 50 parallel paths that are selectively enablable based on these bits. In at least one embodiment, ranges of supply voltages corresponding to a thermocode configuration may not share uniform widths. For example, a first range may be 25-50° C., which has a width of 25° C., while a second range may be 50-65° C., which has a width of 15° C. The widths of the temperature ranges may be designed such that each additional parallel path that is enabled compensates for the increase in the measured temperature.

In some embodiments, each unique thermocode may also correspond to a predetermined amount of supply current I_{CC} to be supplied to the amplifier 112. The below table (2) represents possible amounts of supply current I_{CC} corresponding to unique 4-bit thermocodes:

TABLE 2

| | |
|---|---|
| Supply current I_{CC} to amplifier 112 | Thermocodes |

| | | |
|---|---|---|
| 0 | amperes (A) | 0000 |
| 1 | microampere (μA) | 0001 |
| 3 | μA | 0011 |
| 7 | μA | 0111 |
| 15 | μA | 1111 |

In this exemplary embodiment, the correction circuit 120 may have a different current sources that are selectively enablable (via the parallel lines) such that, based on the thermocode, the amplifier 112 receives a predetermined amount of supply current I_{CC} based on the measured temperature. Here, a first current source may output 1 μA, a second current source may output 2 μA, a third current source may output 4 μA, and a fourth current source may output 8 μA. The outputs of these current sources may be predetermined based on known load current characteristics of the IC within the temperature ranges corresponding to the unique thermocodes. In at least one embodiment, the supply current I_{CC} may exponentially increase as IC temperature increases due to the load current I_{OUT} exponentially increasing as IC temperature increases, as seen in table (2). In general, as the temperature of an IC increases, the load current Jour can rise exponentially due to several factors. One factor can be increased leakage current of transistors within the IC. At higher temperatures, the thermal energy can cause more charge carriers to become active, leading to greater leakage via these transistors. This leakage current contributes to the overall load current drawn by the IC. Additionally, temperature increases can reduce the threshold voltage of these transistors which can cause more current to flow for the same input signal.

Higher IC temperatures can often correlate with a higher load frequency. As this load frequency increases, LDO stability decreases. To compensate, the correction circuit 120 supplies the amplifier 112 with additional supply current I_{CC}, which enhances LDO stability and the ability of the LDO 110 to manage the higher load frequency. A higher supply current means the LDO can source more power to the IC, helping it cope with the increased demand.

While the above example and accompanying description includes a correction circuit 120 configured to modify an amount of supply current I_{CC} supplied to the amplifier 112, the above description of using a thermocode to selectively enable or disable parallel lines may be used to modify any parameter or characteristics of the LDO 110 that affects LDO stability, such as an internal capacitance, a resistor network, the reference voltage V_{REF}, or the like.

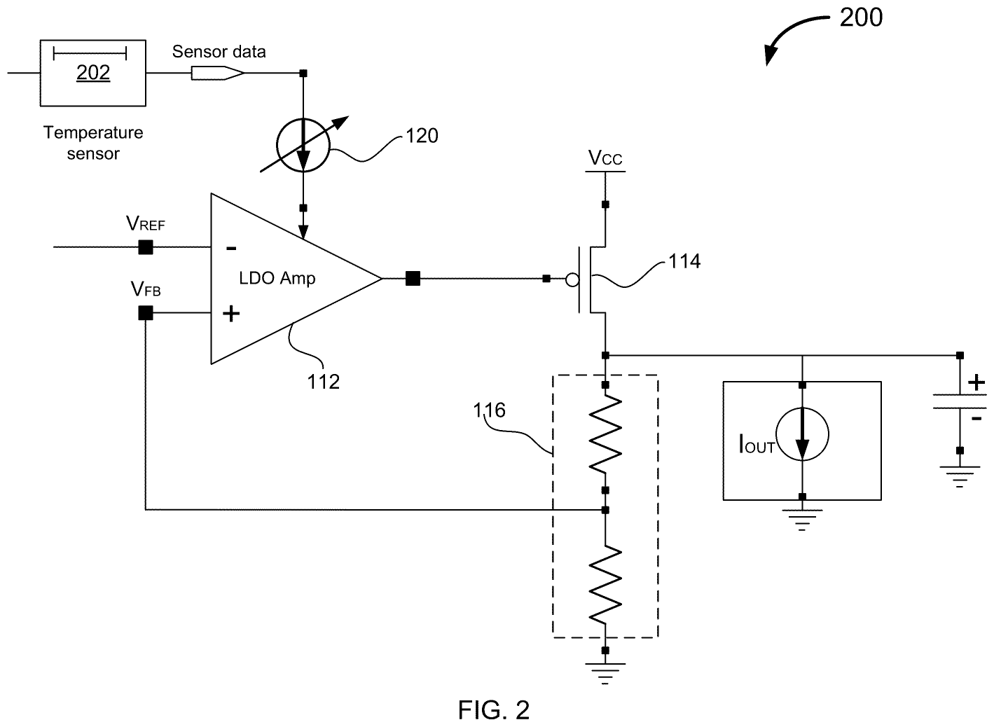

FIG. 2 illustrates a circuit 200 with LDO circuitry, according to one embodiment. The circuit 200 may include some or all of the features described above with respect to the circuit 100 of FIG. 1. In some embodiments, the sensor data may be provided by a temperature sensor 202. The temperature sensor 202 may be a PVT sensor, a thermometer, or other suitable sensor that is capable of measuring a temperature of an IC to which the LDO circuitry provides power regulation. According to embodiments, the correction circuit 120 may be configured to control a supply current I_{CC} supplied to the amplifier 112 based on the sensor data. Here, the correction circuit 120 may be an adjustable current source. According to embodiments, a load current (I_{OUT}) may increase exponentially as temperature increases. The correction circuit 120 may be configured to provide enough supply current I_{CC} to maintain stability of the LDO 110 with the elevated load current I_{OUT} during higher temperatures. Also, the correction circuit 120 may be configured to maintain the supply current I_{CC} and the load current I_{OUT} such that these currents are in phase with each other. To do so, the correction circuit 120 should modify the supply current I_{CC} based on changes in the load current I_{OUT} (e.g., due to temperature change). Maintaining phase correlation between the supply current I_{CC} and the load current I_{OUT} can help with stability of the LDO 110, among other factors.

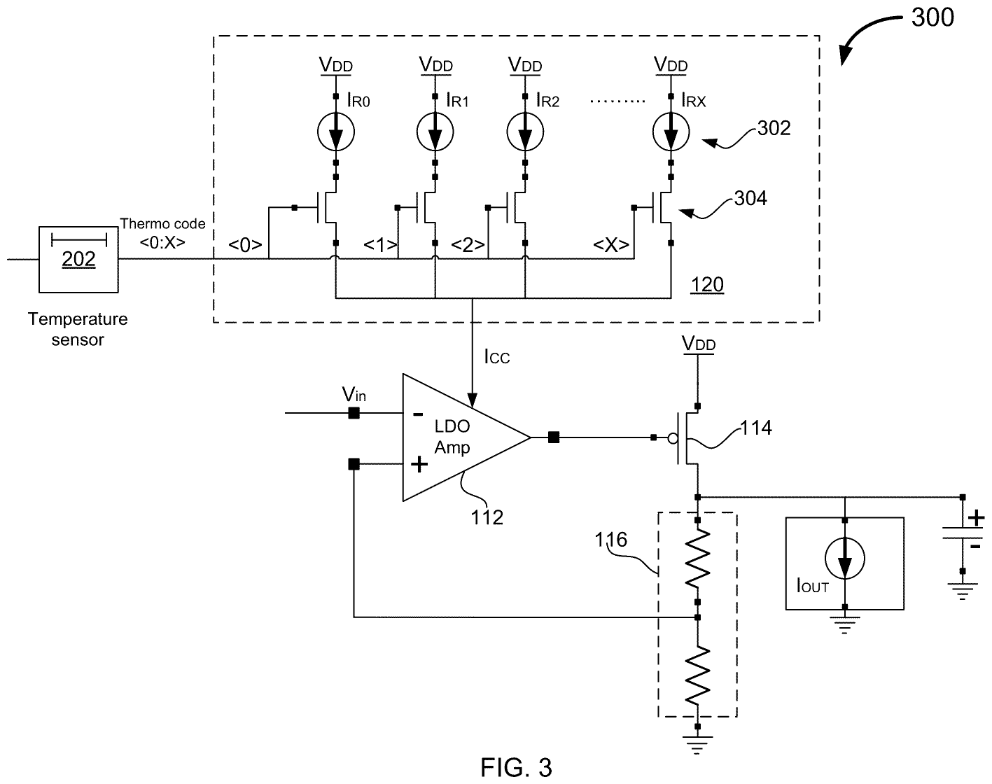

FIG. 3 illustrates a circuit 300 with LDO circuitry, according to one embodiment. The circuit 300 may include some or all of the features described above with respect to the circuit 100 of FIG. 1. The circuit 300 may include some or all of the features described above with respect to the circuit 200 of FIG. 2. As illustrated in FIG. 3, the correction circuit 120 may include parallel paths that, upon being enabled or disabled, modify the supply current I_{CC} provided to the amplifier 112 based on a received thermocode. The parallel paths may each include a fixed current source 302 and a pass element 304. In other words, each of the fixed current sources 302 may be coupled to a different pass element 304, which forms a parallel path between the power supply V_{DD} and the amplifier 112. Each fixed current source may be configured to output different amounts of current. This thermocode may correspond to a measured temperature of an IC to which the circuit 300 provides power regulation. The thermocode may be provided to the correction circuit 120 via parallel lines that each carry a signal representing one bit of the thermocode. For example, signals carried by each of the parallel lines may be in a HIGH state (“1”) or a LOW state (“0”), which represents a respective bit of the thermocode. The thermocode may include any number of bits (e.g., “X” bits). The number of bits of the thermocode may correspond to a range or granularity of the sensor data (e.g., the temperature range representable by the thermocode, the range of temperatures that each unique thermocode represents). The thermocode may be outputted by an analog-to-digital converter (ADC) that converts sensor data (which is analog) into the thermocode. Each pass element 304 of the correction circuit 120 may receive one of these parallel lines. In at least some embodiments, each of the pass elements 304 can receive a different signal each corresponding to a different bit of the thermocode. Here, the parallel paths may be individually enabled or disabled based on their respective corresponding thermocode bit.

In some embodiments, the correction circuit 120 can adjust an amount of supply current I_{CC} supplied to the amplifier 112 based on the thermocode. In the particular circuit configuration illustrated in FIG. 3, if more bits of the thermocode are enabled, more of the parallel paths between the power supply V_{DD} and the amplifier 112 are enabled, and more supply current I_{CC} is provided to the amplifier 112. Likewise, if less bits of the thermocode are enabled, less of the parallel paths are enabled, and less supply current I_{CC} is provided to the amplifier 112. So, as illustrated, these parallel paths may be selectively enabled or disabled based on the thermocode, which represents the measured temperature.

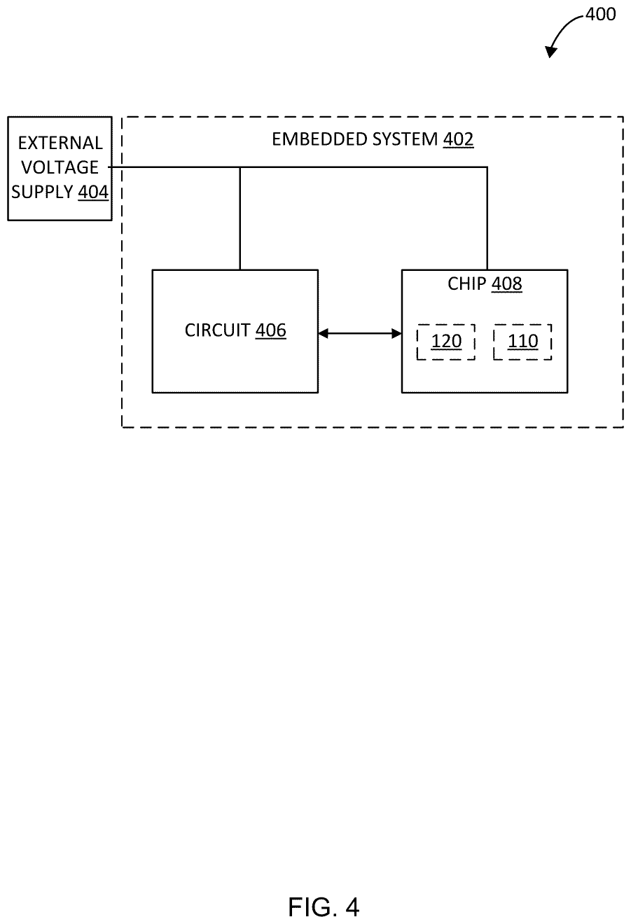

FIG. 4 illustrates a portion of a system 400, according to one embodiment. The system 400 may include an embedded system 402 and an external voltage supply 404. The embedded system 402 may include a circuit 406 and an integrated circuit (IC) 408. The IC 408 may include an LDO, such as the LDO 110, and a correction circuit, such as the correction circuit 120 as described herein.

The circuit 406 may be any circuitry that would benefit from power supply regulation provided by an LDO. For example, the circuit 406 may be a memory controller, a microcontroller, an ADC, a digital-to-analog converter (DAC), radio frequency (RF) components, amplifier(s), sensor interfaces, a field-programmable gate arrays (FPGA), voltage reference(s), flash memory circuitry, a display such as a light emitting diode (LED) display, audio circuitry, a power amplifier, a clock generator, a wireless module such as a wireless local area network (WLAN) module, or the like. The IC 408, via the LDO 110 and correction circuit 120, may provide voltage regulation to the circuit 406. In particular, the LDO circuit may help ensure that operations within the system 400 receive a stable, low-noise power supply, which may help maintain the integrity of data or signals handled by the circuit 406.

In the above description, numerous details are set forth. It will be apparent, however, to one of ordinary skill in the art having the benefit of this disclosure, that embodiments of the present disclosure may be practiced without these specific details. In some instances, well-known structures and devices are shown in block diagram form, rather than in detail, in order to avoid obscuring the description. Additionally, in the above description, reference is made to the accompanying figures which form a part hereof, and in which is shown, by way of illustration, several embodiments of the present disclosure. It is understood that other embodiments may be utilized and structural changes may be made without departing from the scope of the present disclosure.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “receiving,” “adjusting,” or the like, refer to the actions and processes of a computing system, or similar electronic computing device, that manipulates and transforms data represented as physical (e.g., electronic) quantities within the computing system's registers and memories into other data similarly represented as physical quantities within the computing system memories or registers or other such information storage, transmission or display devices.

The words “example” or “exemplary” are used herein to mean serving as an example, instance or illustration. Any aspect or design described herein as “example’ or “exemplary” is not necessarily to be construed as preferred or advantageous over other aspects or designs. Rather, the use of the words “example” or “exemplary” is intended to present concepts in a concrete fashion. As used in this application, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “some embodiments” throughout is not intended to mean the same embodiment or embodiments unless described as such.

Embodiments described herein may also relate to an apparatus for performing the operations herein. This apparatus may be specially constructed for the required purposes, or it may comprise a general-purpose computer selectively activated or reconfigured by a computer program stored in the computer. Such a computer program may be stored in a non-transitory computer-readable storage medium, such as, but not limited to, any type of disk including floppy disks, optical disks, CD-ROMs and magnetic-optical disks, read-only memories (ROMs), random access memories (RAMs), EPROMS, EEPROMs, magnetic or optical cards, flash memory, or any type of media suitable for storing electronic instructions. The term “computer-readable storage medium” should be taken to include a single medium or multiple media (e.g., a centralized or distributed database and/or associated caches and servers) that store one or more sets of instructions. The term “computer-readable medium” shall also be taken to include any medium capable of storing, encoding, or carrying a set of instructions for execution by the machine and that causes the machine to perform any one or more of the methodologies of the present embodiments. The term “computer-readable storage medium” shall accordingly be taken to include, but not be limited to, solid-state memories, optical media, magnetic media, and any medium that is capable of storing a set of instructions for execution by the machine and that causes the machine to perform any one or more of the methodologies of the present embodiments.

The algorithms and displays presented herein are not inherently related to any particular computer or other apparatus. Various general-purpose systems may be used with programs in accordance with the teachings herein, or it may prove convenient to construct a more specialized apparatus to perform the required method steps. The required structure for a variety of these systems will appear from the description below. In addition, the present embodiments are not described with reference to any particular programming language. It will be appreciated that a variety of programming languages may be used to implement the teachings of the embodiments as described herein.

The above description sets forth numerous specific details, such as examples of specific systems, components, methods, and so forth, in order to provide a good understanding of several embodiments of the present disclosure. It will be apparent to one skilled in the art, however, that at least some embodiments of the present disclosure may be practiced without these specific details. In other instances, well-known components or methods are not described in detail or presented in simple block diagram format to avoid unnecessarily obscuring the present disclosure. Thus, the specific details set forth above are merely exemplary. Particular embodiments may vary from these exemplary details and still be contemplated to be within the scope of the present disclosure.

It is to be understood that the above description is intended to be illustrative and not restrictive. Many other embodiments will be apparent to those of skill in the art upon reading and understanding the above description. The scope of the disclosure should, therefore, be determined with reference to the appended claims, along with the full scope of equivalents to which such claims are entitled.

In the above description, for purposes of explanation, numerous specific details are set forth in order to provide a thorough understanding of the present disclosure. It will be evident, however, to one skilled in the art that the present disclosure may be practiced without these specific details. In other instances, well-known circuits, structures, and techniques are not shown in detail, but rather in a block diagram in order to avoid unnecessarily obscuring an understanding of this description.

Reference in the description to “one embodiment,” “an embodiment,” or “some embodiments” means that a particular feature, structure, or characteristic described in connection with the embodiment(s) is included in at least one embodiment of the disclosure. The phrase “in one embodiment” or “in some embodiments” located in various places in this description does not necessarily refer to the same embodiment(s).

What is claimed is:

1. A circuit comprising:
A low dropout regulator (LDO) comprising an amplifier configured to supply a voltage based on a comparison of a feedback loop voltage and a reference voltage; and
a correction circuit coupled to the amplifier, wherein the correction circuit is configured to dynamically adjust an amount of current supplied to the amplifier based on a measured temperature.

2. The circuit of claim 1, wherein the correction circuit comprises a plurality of current sources that are configured to selectively couple to the amplifier.

3. The circuit of claim 2, wherein a first current source of the plurality of current sources and a second current source of the plurality of current sources are configured to output different amounts of current.

4. The circuit of claim 2, wherein the plurality of current sources are configured to selectively couple to the amplifier based on a thermometer code representing the measured temperature.

5. The circuit of claim 4, wherein each of the plurality of current sources are coupled to a different pass element of a plurality of pass elements, and wherein each of the plurality of pass elements comprises a control terminal that is configured to receive a portion of the thermometer code.

6. The circuit of claim 1, wherein measured temperature corresponds to an integrated circuit (IC) upon which the circuit is disposed.

7. The circuit of claim 1, wherein the correction circuit provides a first amount of current at a first time based on a first measured temperature, and a second amount of current greater than the first amount of current at a second time based on a second measured temperature, and wherein the second measured temperature is greater than the first measured temperature.

8. A system comprising:
a controller; and
a circuit configured to provide power regulation to the controller, the circuit comprising:
an amplifier configured to supply a voltage based on a comparison of a feedback loop voltage and a reference voltage; and
a correction circuit coupled to the amplifier, wherein the correction circuit is configured to dynamically adjust an amount of current supplied to the amplifier based on a measured temperature.

9. The system of claim 8, wherein the correction circuit comprises a plurality of current sources that are configured to selectively couple to the amplifier.

10. The system of claim 9, wherein a first current source of the plurality of current sources and a second current source of the plurality of current sources are configured to output different amounts of current.

11. The system of claim 9, wherein the plurality of current sources are configured to selectively couple to the amplifier based on a thermometer code representing the measured temperature.

12. The system of claim 11, wherein each of the plurality of current sources are coupled to a different pass element of a plurality of pass elements, and wherein each of the plurality of pass elements comprises a control terminal that is configured to receive a portion of the thermometer code.

13. The system of claim 8, wherein measured temperature corresponds to an integrated circuit (IC) upon which the circuit is disposed.

14. The system of claim 8, wherein the correction circuit provides a first amount of current at a first time based on a first measured temperature, and a second amount of current greater than the first amount of current at a second time based on a second measured temperature, and wherein the second measured temperature is greater than the first measured temperature.

15. A circuit comprising:
a low dropout regulator (LDO); and
a plurality of pass elements each coupled to the LDO, wherein each of the plurality of pass elements is configured to receive a different signal of a plurality of signals, and wherein the plurality of signals represent a thermocode.

16. The circuit of claim 15, wherein each pass element is coupled to a different current source.

17. The circuit of claim 16, wherein the plurality of pass elements are coupled to an amplifier of the LDO.

18. The circuit of claim 16, wherein each current source is configured to output a different amount of current.

19. The circuit of claim 16, wherein, based on the thermocode, a first amount of current is provided to the LDO at a first time and a second amount of current different than the first amount of current is provided to the LDO at a second time.

20. The circuit of claim 15, wherein the thermocode represents a measured temperature of the circuit.
